(19) United States
(12) Patent Application Publication
(10) Pub. No.: US 2026/0320284 A1
(43) Pub. Date: Oct. 15, 2026

(54) SYSTEMS AND METHODS FOR LARGE LANGUAGE MODEL BASED TOPIC MODELING

(71) Applicant: JPMORGAN CHASE BANK, N.A., New York, NY (US)

(72) Inventors: Fanny SILAVONG, London (GB); Sae Young MOON, Edmonton (CA); Myeongjun JANG, Oxford (GB); Chunyang XIAO, Milton Keynes (GB); Antonios GEORGIADIS, London (GB); Haoyan LUO, London (GB)

(21) Appl. No.: 19/461,362

(22) Filed: Jan. 27, 2026

(30) Foreign Application Priority Data
Mar. 19, 2025 (GR) 20250100195

(51) Int. Cl. G06F 40/166; G06F 40/289

(52) U.S. Cl. CPC G06F 40/166; G06F 40/289

(57) ABSTRACT

Systems and methods for large language model-based topic modeling are disclosed. A method may include: receiving a plurality of text documents; indexing, by the computer program, the plurality of text documents; storing the indexed plurality of text documents in a database; selecting a batch of the plurality of text documents from the database; segmenting each document in the batch into smaller elements; clustering the smaller elements the batch using embeddings for each element; selecting elements in each cluster for topic generation; identifying, using a large language model (LLM), granular topics for each cluster; organizing the granular topics into a topic hierarchy; generating topic insights on topics from the granular topics; and evaluating the topic insights.

### RELATED APPLICATIONS

This application claims priority to, and the benefit of, Greek Patent Application No. 20250100195, filed Mar. 19, 2025, the disclosure of which is hereby incorporated, by reference, in its entirety.

### BACKGROUND

### 1. Field of the Invention

Embodiments relate generally to systems and methods for large language model-based topic modeling.

### 2. Description of the Related Art

Topic modeling is a frequently used Natural Language Processing (NLP) approach to discover hidden semantic patterns portrayed by a text corpus and automatically identify topics that exist inside the text corpus. It has a broad range of practical usage for text mining and data analysis in research and industry. Current techniques for topic modeling are often keyword or concept based, which provide limited value. For example, output generally has limited interpretability and does not capture important nuances or details. In addition, the topics may not be aligned to business interests, as topics are often captured based on word frequency rather than business insights. Further, existing topic modeling approaches that use large language models (LLMs) do not generate granular topic representations that are of high quality, accurate, and cost/time effective, are not scalable or cost effective as they are costly in terms of latency and LLM costs.

### SUMMARY OF THE INVENTION

Systems and methods for large language model-based topic modeling are disclosed. In one embodiment, a method may include: receiving, by a computer program, a plurality of text documents; indexing, by the computer program, the plurality of text documents; storing, by the computer program, the indexed plurality of text documents in a database; selecting, by the computer program, a batch of the plurality of text documents from the database; segmenting, by the computer program, each document in the batch into smaller elements; clustering, by the computer program, the smaller elements the batch using embeddings for each element; selecting, by the computer program, elements in each cluster for topic generation; identifying, by the computer program and using a large language model (LLM), granular topics for each cluster; organizing, by the computer program, the granular topics into a topic hierarchy; generating, by the computer program, topic insights on topics from the granular topics; and evaluating, by the computer program, the topic insights.

In one embodiment, the batch may be selected using representative sampling.

In one embodiment, the method may also include generating, by the computer program and using a large language model, targeted summaries of each text document in the batch.

In one embodiment, the method may also include preparing, by the computer program, a shorter version of each of the text documents in the batch using data chunking and/or data truncation before generating the targeted summaries.

In one embodiment, the step of organizing the granular topics into a topic hierarchy may include: creating, by the computer program and for each cluster, a multi-view embedding vector by concatenating a centroid of the text element embeddings, an embedding of a topic name for the granular topic, and an embedding of a topic description for the granular topic; and generating, by the computer program and using the LLM, the topic hierarchy based on the multi-view embedding vectors.

In one embodiment, the method may also include: training, by the computer program, a distillation model; and distilling, by the computer program, labels for the indexed plurality of text documents in the database.

In one embodiment, the method may also include performing, by the computer program, semantic filtering and semantic deduplication on the labels.

In one embodiment, the semantic filtering may include key phrase extraction.

In one embodiment, the semantic deduplication may include encoding and clustering topics.

According to another embodiment, a non-transitory computer readable storage medium may include instructions stored thereon, which when read and executed by one or more computer processors, cause the one or more computer processors to perform steps comprising: receiving a plurality of text documents; indexing the plurality of text documents; storing the indexed plurality of text documents in a database; selecting a batch of the plurality of text documents from the database; segmenting each document in the batch into smaller elements; clustering the smaller elements the batch using embeddings for each element; selecting elements in each cluster for topic generation; identifying, using a large language model (LLM), granular topics for each cluster; organizing the granular topics into a topic hierarchy; generating topic insights on topics from the granular topics; and evaluating the topic insights.

In one embodiment, the batch may be selected using representative sampling.

In one embodiment, the non-transitory computer readable storage medium may also include instructions stored thereon, which when read and executed by the one or more computer processors, cause the one or more computer processors to perform steps comprising: generating targeted summaries of each text document in the batch using a large language model.

In one embodiment, the non-transitory computer readable storage medium may also include instructions stored thereon, which when read and executed by the one or more computer processors, cause the one or more computer processors to perform steps comprising: preparing shorter version of each of the text documents in the batch using data chunking and/or data truncation before generating the targeted summaries.

In one embodiment, the step of organizing the granular topics into a topic hierarchy may include: creating, for each cluster, a multi-view embedding vector by concatenating a centroid of the text element embeddings, an embedding of a topic name for the granular topic, and an embedding of a topic description for the granular topic; and generating, using the LLM, the topic hierarchy based on the multi-view embedding vectors.

In one embodiment, the non-transitory computer readable storage medium may also include instructions stored thereon, which when read and executed by the one or more computer processors, cause the one or more computer processors to perform steps comprising: training a distillation model; and distilling labels for the indexed plurality of text documents in the database.

In one embodiment, the non-transitory computer readable storage medium may also include instructions stored thereon, which when read and executed by the one or more computer processors, cause the one or more computer processors to perform steps comprising: performing semantic filtering and semantic deduplication on the labels.

In one embodiment, the semantic filtering may include key phrase extraction.

In one embodiment, the semantic deduplication may include encoding and clustering topics.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a system for large language model-based topic modeling according to an embodiment;

FIG. 2 depicts a method for large language model-based topic modeling according to an embodiment;

FIG. 3 depicts a method for topic modeling according to an embodiment;

FIG. 4 depicts an exemplary computing system for implementing aspects of the present disclosure.

### DETAILED DESCRIPTION OF PREFERRED EMBODIMENTS

Systems and methods for large language model-based topic modeling are disclosed.

Embodiments may provide a comprehensive pipeline that generates relevant topic insights. In embodiments, text-based data may be ingested in various formats (e.g., short to long texts, clean to noisy texts) and may be pre-processed to enable cost-effective and performant topic insight generation. For example, each text document may be segmented into smaller elements, and these smaller elements may be clustered. Granular topics for the clusters may be identified, and the granular topics may be used to generate and evaluate topic insights.

Embodiments may scale topic tagging to very large datasets through label distillation.

Embodiments may summarize and visualize topic insights, which may aid in decision making.

In embodiments, the topic insights may be evaluated through automatic and LLM-based metrics to ensure reliability of insights.

Embodiments may provide a targeted summarization module that may solve targeted summarization tasks given long or noisy texts.

Embodiments may provide a topic modeling module that may build a hierarchical topic taxonomy given unlabeled text data.

Embodiments may provide a label distillation module that may predict multi-label classes given labelled training dataset.

Embodiments may provide an evaluation module that may evaluate the quality of labels or categories assigned to a text, given a labelled dataset.

As used herein, an insight may be any information that is not directly specified in data, but is underlying in the data and can be inferred from analysis. For example, the generated granular topics and its hierarchy may be considered to be considered as insights as they are not directly revealed in the data. Also, the proportion of each topic in a corpus, how they change in different time stamps, may be considered to be insights.

Embodiments may perform topic modelling on the text documents in a batch, which facilitates the granular topic generation.

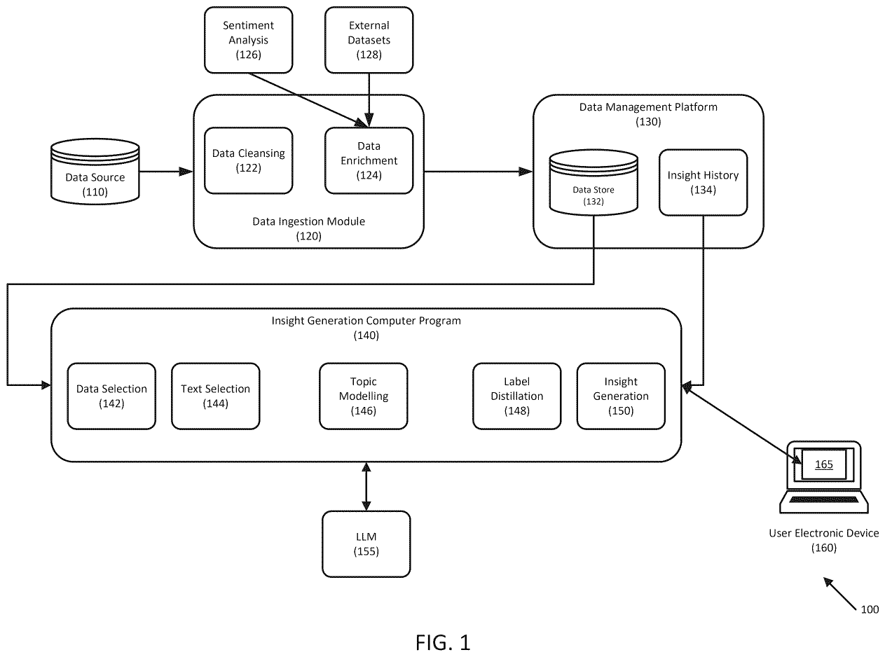

Referring to FIG. 1, a system for large language model-based topic modeling is disclosed according to an embodiment.

Data source 110 may be a source of text documents, including conversational text data, surveys, news, search queries, articles, etc., and portions or snippets of any of these text documents.

Data ingestion module 120 may ingest text documents from data source 110. This may include using cleansing module 122 and data enrichment module 124. Data enrichment module 124 may enrich text documents with a sentiment from sentiment analysis module 126 and/or metadata from external datasets 128. External metadata may include additional variables that pertain to the text samples in the dataset, such as the date-time that the text document was created, metadata of the user that wrote the text document, etc.

Data management platform 130 may include datastore 132 that may store ingested text document, and insight history 134, which may store historical insight information.

Insights generation computer program 140 may generate insights for text documents in datastore 132 and may also include historical insights. The historical insights may include results and logs from previous insight generation runs. Insights generation computer program 140 may include data selection module 142, text selection module 144, topic modeling module 146, label distillation module 148, and insights generation module 150.

The modules of insights generation computer program 140 may be configured differently depending on user needs, dataset characteristics, etc. For example, if the dataset from data source 110 is very large, data selection module 142 may be enabled to draw a smaller sample for insights generation module 150. Label distillation module 148 may then be enabled to distill the labels on the larger dataset.

As another example, if the text data is very noisy and/or long, summarization in the text selection module may be enabled to create a shorter and/or cleaner text to run insight generation module 150 on.

Then we might enable label distillation to distill the labels on the larger unlabeled dataset.

System 100 may further include user electronic device 160 that may execute user computer program 165. User computer program 165 may receive the insights from insights generation computer program 140 and may present them to the user.

System 100 may further include LLM 155. LLM 155 may interface with one or more modules in insights generation computer program 140, including text selection module 144, topic modeling module 146, label distillation module 148, and insights generation module 150.

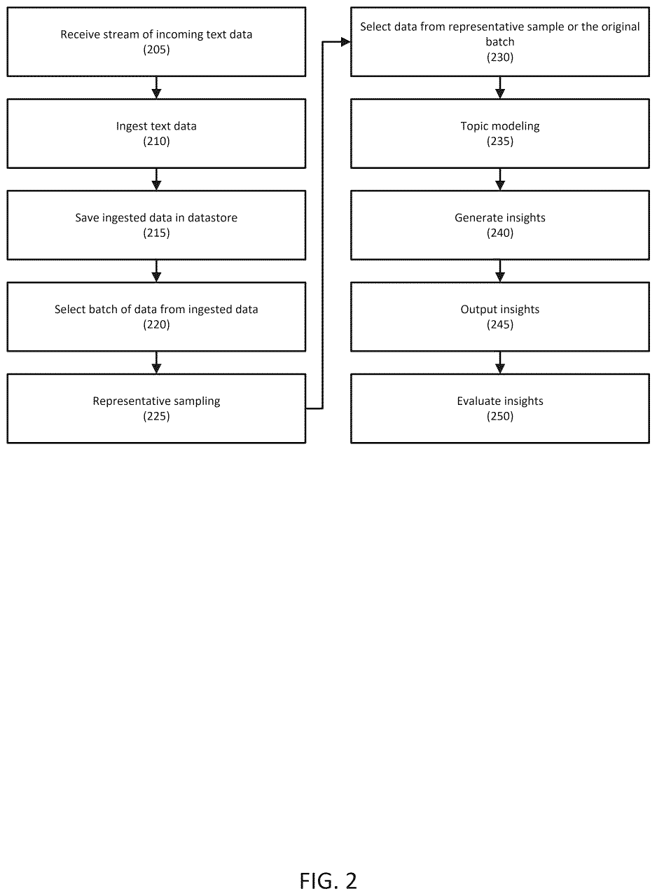

Referring to FIG. 2, a method for large language model-based topic modeling is disclosed according to an embodiment.

In step 205, a plurality of text documents may be received. The text documents may be from conversations, documents, news article, surveys or reviews, etc., and portions thereof.

In one embodiment, the plurality of text documents may be received in a stream.

In step 210, the text documents may be ingested. This may include data cleansing, such as text extraction and parsing, as well as data enrichment. In one embodiment, the text documents may be enriched with a sentiment (e.g., for the entire text documents or segments thereof), and/or with metadata from one or more external datasets.

In step 215, the ingested text documents may be stored in a datastore. The text documents may be indexed in the datastore.

For example, an index in a datastore may refer to a collection of text documents. In general, the collection of text documents may include text documents that have been ingested in the same time period. A unique datapoint may only be indexed to the datastore once to eliminate duplicate data stored. The collection of text documents, along with their respective metadata, may be stored or indexed into the data store so that they can be retrieved for insight generation in downstream processes. Metadata associated with the text documents, such as date or user meta data, can be used to query the datastore and retrieve text documents for insight generation.

In step 220, a batch (e.g., a subset) of text documents may be selected for LLM-based topic modeling. For example, the user may select the batch text documents data that is to be run for insight generation. For example, if the user wishes to generate insights for text documents collected in a specific time period, text documents for that period may be retrieved, and insight generation may be run on those text documents. The process may be either manually triggered by the user, or conducted automatically in a periodic fashion.

In one embodiment, different weightings may be applied to different data sources. For example, a data source that provides chats may be weighted differently from a data source that provides articles.

In step 225, representative sampling may optionally be used to sample a dataset of text documents from the batch. Representative sampling allows the size of the dataset that is provided to the LLM to be limited, while still sampling enough to obtain high quality and representative topic insights from the dataset. If the batch is small (e.g., less than 5000 text documents), the representative sampling may be turned off and the entire batch of data may be sent for LLM-based topic modeling. If the batch is large (e.g., greater than 5000 text documents), representative sampling will allow users to run costly LLM-based topic modeling on a restricted sample size, thereby limiting costs and latency. Note that the threshold used in the example is illustrative, and the threshold may vary as is necessary and/or desired.

For example, diverse sets of text documents may be sampled based on variable, ground truth labels, chatbot conversation journey tags (e.g., from a chatbot platform), failure point detection, etc. The text documents may be sampled from the text documents that have been ingested and indexed to the data store.

The amount of text documents to sample may be based on a user defined minimum cluster size and a probability hyperparameter, embodiments may automatically detect an ideal amount of text documents to sample for the topic modeling module. In one embodiment, the optimal sampling may be conducted in a probabilistic manner, so that even the least prevalent topics are likely to be included.

The minimum cluster size refers to the minimum number of samples that should be associated with the least-prevalent topic. This is a proxy variable to help determine the maximum number of topics that can be covered in the sample dataset. The probability hyperparameter represents the acceptable probability of failing to capture the least-prevalent topic. Given these variables, the sampling method may use Bayesian probabilistic methods to approximate the optimal number of samples.

Next, in step 230, text documents from the representative sample dataset, or from the original batch dataset, may be selected. In one embodiment, relevant text data may be selected for downstream LLM-based topic modeling. Segments, summaries, the entire text documents, etc., may be selected as is necessary and/or desired.

For example, for each text document in the sampled dataset or original batch, text selection may select the specific text that gets ingested into the LLM-based topic modeling module. The goal is to prepare clean and comprehensible text of reasonable length to enhance the performance of LLM-based topic modeling.

In one embodiment, a targeted summary of the original text documents in the representative sample or batch dataset may be generated. The targeted summary may be based, for example, on an interest, such as failure points. Targeted summarization may enable users to summarize complex/noisy text documents, specifically for the purpose of insight generation. Embodiments may verbalize implicit events from the text documents (e.g., chatbot failure points), may retain key content relevant for topic insight generation, etc. An illustrative prompt for targeted summarization is as follows:
You are a professional top-performing data analyst that generates insights and reports to support decision-making and improve business processes.
You Are Reviewing {text} in the Following Domain:
{{domain_description}}
Use the following ‘Summary Guidelines’ to generate a summary:
The {SUMMARY} must contain information that relates to the {TOPIC_DESC} and {TOPIC_DEFN}.
The {SUMMARY} must contain specific keywords and important phrases that were mentioned in the {TEXT}, if it relates to the {TOPIC_DESC} and {TOPIC_DEFN}.
The {SUMMARY} may omit meaningless sentences in the {TEXT}, such as greetings.
The {SUMMARY} MUST NOT contain any new information that is not present in the {TEXT}. DO NOT add any extra details or other texts.
The {SUMMARY} is a re-writing of the content written in the {TEXT}.
DO NOT answer any questions or try to respond to anything in the {TEXT}.
   Never generate URLs or links apart from those present in the {TEXT}.
   You CANNOT respond with videos, memes, photos, code, or other non-English language content.
Your response should never contain toxic, or NSFW material.
Summarize the following:
{ASPECT}: {DEFINITION}
. . .

In one embodiment, data chunking and/or data truncation may be used to prepare shorter versions of the text documents. For example, given long text documents (e.g., newspaper articles), embodiments may truncate the text documents before topic modeling is performed. This is a simple pre-processing step that may decrease the amount of text that needs to be processed to obtain insights on certain types of text documents (e.g., topic insights on the article headers and the first paragraph). As another example, given a long text document (e.g., educational content), embodiments may chunk the text document into smaller sections prior to topic modeling.

In step 235, topic modeling may be performed. In one embodiment, LLM-based topic modeling may be used to extract multiple topic representations per text document. In general, topic modeling may include extracting topic representations from the selected text, enhancing the cost/latency efficiency through smart clustering, further increasing the relevance of topics to business with optional refinements of granular topics, and enhancing topic insight experience through optional topic hierarchy detection.

In one embodiment, the topic modeling process may obtain domain/topic definitions from businesses to detect topics that align with interests.

Embodiments may also take textual input from the users to detect custom domain/topic definitions. These definitions may be incorporated throughout the topic generation processes, allowing the topic generation processes to generate topic insights that are tailored to business needs and interests.

In one embodiment, a topic hierarchy may be provided, and may be used to aid in insight exploration.

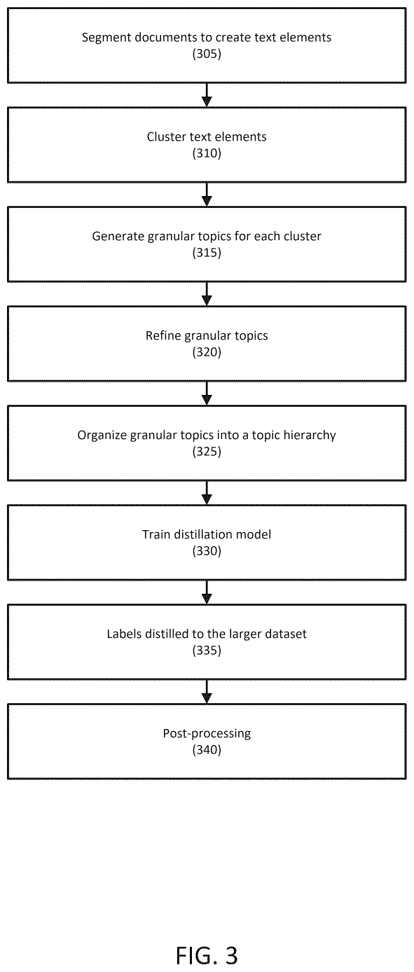

For example, referring to FIG. 3, a method for topic modeling is provided according to an embodiment

First, in step 305, each document in the batch may be segmented into smaller units to create text elements for topic modeling. The units may be, for example, a sentence, a paragraph, a user-defined custom unit (e.g., a phrase with at least a certain word count), etc.

Next, in step 310, the selected text elements may be clustered. For example, for each text element, embeddings may be obtained using an embedding model, such as a sentence transformer model. Dimensionality reduction may optionally be applied on the embeddings to improve downstream clustering performance, efficiency and potentially quality.

Any suitable clustering method may be used, including agglomerative clustering methods, HDBSCAN, K-Means, etc.

Next, in step 315, the topic modeling module may select text elements from the segmented cluster for topic generation. The topic modelling module takes the text elements of each cluster as inputs and prompts LLM to generate the name and description of topic that can represent the cluster. A user may add “topic_definition” to the prompt in order to provide more specific guidelines when generating the topic names and descriptions. If the size of a cluster is too large, representative text elements for each cluster may be sampled. Once the topic names are generated, all the text elements belonging to a cluster are assigned the corresponding topic name and corresponding description.

An illustrative prompt to a LLM is:
You will receive a list of text segments that belong to the same cluster. Each text segment is identified by a unique ID. Given the segments, your task is to read the contents, then generate a topic that can describe as many text segments from this group as possible.
Along with the topic, you need to generate a short description of the meaning of the topic given by yourself.
[Instructions]
   The topic should be a short phrase of {n_topic_words-1}-{n_topic_words} words.
   The description should be no more than two sentences.
   The description needs to start with phrase ‘This topic is about . . . ’
{% if {topic_definition} is not none %}
[Topic Definition]
{topic_definition}
{% endif %}
{% if ({previous_topic} is not none) and ({feedback} is not none) %}
This cluster was previously named as {previous_topic}. Here is some feedback on how you can improve the quality of the topic: {feedback} {% endif %}
Please keep in mind that the text segments with different ID does not originate from the same document.
Text Segments: {TEXT_ELEMENTS}
[Your Response]

Next, in step 320, the generated granular topics may be refined through iterative topic refinement loop. In one embodiment, each topic may be given to a coherence evaluator, which assesses how closely the generated topic name and description are related to the text elements assigned to that topic in the cluster.

A refinement iteration may include the following steps. First, for topics assigned a low coherence score, the text elements may be separated into two smaller clusters. The topics for these new clusters may then be re-named by prompting the LLM with the prompt, this time incorporating the feedback from the coherence evaluator.

In one embodiment, a coherence evaluator may be an LLM agent that may prompt the LLM, and may receive a coherence score for each topic, along with feedback and a mark denoting whether further separation is needed or not. An illustrative prompt to a LLM for may be as follows:
You'll receive a list of text segments, a topic assigned to the given corpus, and its corresponding description.
Your task is to calculate the Topic Coherence score, which evaluates how closely the topic name and the description match with the text segments.
Assign an overall Topic Coherence score from 1 to 10 (including 0.5 increments), where:
   10=High topic coherence: The topic name and description align very well with the text segments.
   1=Low topic coherence: The topic name and description covers too broadly compared to the text segments.
If the topic coherence score is sufficient and does not require additional separation:
   specify the field ‘need_separation’ as False.
   leave the fields ‘feedback’ as null.
If the topic coherence score is low and requires separation, please:
   Specify the name of the problematic topic in the ‘topic’ field.
   Specify the field ‘need_separation’ as True.
   Provide detailed feedback in the ‘feedback’ field by addressing the following points:
   Explain the aspects of the topic and description that do not align well with the text segments.
   Offer concrete suggestions to improve the coherence between the topic and the text segments.
List of Text Segments: {text_segments}
Assigned Topic: {topic_name}
Topic Description: {topic_description}
[Your Response]

In another embodiment, after the coherence refinement, the topics may be assessed by a diversity evaluator, which evaluates how distinctive each topic is from the others. The diversity evaluator identifies topics with significant overlap and provides on how merging them could enhance overall diversity.

In one embodiment, the diversity evaluator may be an LLM agent that prompts the LLM. Given the topic names and descriptions of all generated topic after coherence evaluation—split operation, it will return which topics need to be merged together, along with overall diversity score. The identified overlapping topics may then be merged, and the topic names and descriptions for the resulting text elements may be re-generated by prompting LLM with a prompt, this time incorporating the feedback from the diversity evaluator.

An illustrative prompt for is as follows:
You will receive a list of topics, which are identified by a unique ID, and their corresponding descriptions.
Your task is to calculate the Topic Diversity score, which assesses how distinct the topics are from one another and helps identify if any topics need to be merged or are too similar.
Assign an overall Topic Diversity score from 1 to 10 (including 0.5 increments), where:
   10=High topic diversity: The topics are very distinct from one another.
   1=Low topic diversity: Some topics are very similar and may need to be merged.
If the topic diversity score is sufficient and does not require merging:
   specify the field ‘need_merge’ as False.
   leave the fields ‘feedback’ and ‘topics_to_merge’ as null.
If the topic diversity score is low and requires merging, please:
   Specify the field ‘need_merge’ as True.
   Provide detailed feedback in the ‘feedback’ field by addressing the following points:
      Explain which topics are too similar and why they should be merged.
      Offer concrete suggestions on how to improve topic diversity by merging similar topics.
   For each group of similar topics, list the IDs of the TWO most similar topics to be merged in the ‘topics_to_merge’ field.
Topics and Descriptions: {topic_results}
[Your Response]

In another embodiment, refined topics may be re-evaluated by the coherence and diversity evaluators. The results of the initial coherence and diversity evaluation constitute pre-refinement report, while those from the re-evaluation compose the post-refinement report.

A planning agent may assess whether improvements have been achieved through the refinement process by comparing the pre-and post-refinement reports. In one embodiment, the planning agent may be an LLM agent that prompts the LLM using pre-and post-refinement reports. If an improvement is verified, the refined topics are returned; otherwise, the topics prior to refinement are restored and a tolerance parameter is increased by one. The refinement iteration proceeds until it reaches a number of maximum iterations, or the tolerance parameter reaches a maximum tolerance, both of which may be defined by a user.

An illustrative prompt to a LLM is as follows:
You will receive two topic modeling evaluation reports: one from before and one from after the current refinement iteration.
Your task is to determine whether there has been an improvement in the topic modeling results based on these reports.
[Instruction]
For making your decision, consider the following aspects:
1) Overall Score Comparison: Compare the overall scores from both reports. An improvement is indicated if the post-refinement report has a higher overall score than the pre-refinement report.
2) Strengths and Weaknesses: Analyze the strengths and weaknesses highlighted in both reports. Look for areas where the post-refinement report shows fewer weaknesses or improved strengths compared to the pre-refinement report.
3) Number of Topics that Need Refinement: Count the number of topics that were identified as needing refinement in both reports. An improvement is indicated if the post-refinement report has fewer topics requiring refinement than the pre-refinement report.
4) Specific Feedback Analysis: Review the specific feedback provided for each topic in both reports. Check how severe the issues were in the pre-refinement report and whether they have been adequately addressed in the post-refinement report. Look for positive changes or resolved issues in the post-refinement report compared to the pre-refinement report.
If the improvement criteria are met, indicate ‘is_improved’ as ‘True’. Otherwise, indicate ‘is_improved’ as ‘False’. Also, provide a brief explanation of your decision in ‘reason’ field.
Pre-refinement Report: {pre_report}
Post-refinement Report: {post_report}
[Your response]

The topics may optionally be filtered for topics that fit with a list of themes of interest, and topics that do not fit may be identified as “others.”

Next, in step 325, the granular topics may be organized into a topic hierarchy of varying levels. The overall process is similar to the step 315; however, the key difference is the use of multi-view embedding vector. Specifically, for each cluster, which may include text elements, a topic name, and a topic description, a multi-view embedding vector may be created by concatenating the centroid of the text element embeddings, the embeddings of the topic name, and the embeddings of the topic description. Subsequently, clustering may be performed on the multi-view embeddings to group similar topics, followed by prompting LLM to produce the names and descriptions of higher topics by employing prompts.

As a result, each document is segmented into text elements, with each element assigned a unique topic name. This approach enables the representation of a document multiple topics and allows for the computation of each topic's contribution to the document by calculating the proportion of text elements assigned to each topic.

In step 330, a distillation model may be trained. For example, the distillation model may be trained using any pre-trained classification, or a specialized model designed to enhance topic distillation by leveraging topic representations. The output of the topic modelling module may be used to train the distillation model. For example, the output will consist of each text being labelled with topic labels. This labelled dataset may be used to train a classification/distillation model.

In step 335, the labels may be distilled for the larger dataset. For example, the unlabeled dataset may be the data from the original batch that was not included in the representative sample, or data from a completely different batch. Topic representations will be assigned to every text sample in the unlabeled dataset. In one embodiment, a multi-label classifier may be trained based on a topic-labelled dataset to assign topics to large datasets. This topic-labelled dataset may be obtained from the topic modeling module upstream, or an externally labelled dataset (e.g., a human labelled dataset). Samples that are out of distribution may be detected and assigned to new topic representations. Embodiments may support out-of-distribution detection on unlabeled dataset, and may optionally generate new topics on the identified out-of-distribution documents. For example, embodiments may provide 2-stage out-of-distribution detection via 1) Maximum Softmax Probability (MSP) filtering and 2) Mahalanobis distance (MD) calculations.

For example, label distillation may support two methods for addressing data insufficiency (e.g., a lack of sample datasets): LLM-based Augmentation, where an LLM is prompted to generate additional samples for topics with insufficient documents; and a prompt-free framework for few-shot fine-tuning that leverages contrastive learning on a small number of labeled pairs.

In step 340, post-processing may be run on the unlabeled dataset that was not selected as the batch data to filter possible model errors and deduplicate similar topics, obtaining final/clean topics. The post-processing may be performed on any data that is unlabeled to be categorized with topics that were discovered by the topic modelling module.

Semantic post-processing may be an optional step in the topic distillation pipeline designed to enhance the quality and relevance of the predicted topics. It consists of two main components: semantic filtering and semantic deduplication, and may filter out irrelevant topics that may arise from model hallucinations (due to insufficient training data or untrained models).

Semantic filtering may include key phrase extraction (e.g., may use a keyword extractor, such as YAKE (Yet Another Keyword Extractor) to extract key phrases. Topics and key phrases may be encoded into embeddings; the cosine similarity may be calculated, and topics below a similarity threshold (e.g., filter topics that are too dissimilar to document/potentially hallucinated) may be filtered.

Semantic deduplication may include encoding and clustering topics using, for example, K-means clustering. The cosine similarity may be calculated between the topics and the cluster centers. Unique topics may be retained by selecting instances with the lowest similarity within clusters. The topics are the final list of topics/topic hierarchy that is outputted from the distillation module. These topics may include original topics discovered from topic modelling and any new topics discovered by distillation module.

Referring again to FIG. 2, in step 240, insights may be generated based on current topics from the topic modelling and past topics detected. For example, topics across different batches of time (e.g., different years) may be computed and compared to understand topic trends across time. Further, the frequency of texts assigned to topics may be aggregated to view the top-most prevalent topics contained in dataset. At this step, a summary for each topic can be generated to enhance interpretability. For example, the topic representations along with representative samples that belong to the topic may be provided to an LLM Summarizer to generate a longer summary of the topic, providing further information to the user.

In step 245, insights may be output. For example, quantification (e.g., statistical diagrams of the insights generated), trends (e.g., increasing or decreasing trends), outliers, sentiments (e.g., based on aspect-based analysis), taxonomy alignment (e.g., mapping topics that belong to a label or a category), high-level statistics (e.g., high-level comparisons, statistics, visualizations, or insights), etc.

In one embodiment, stored insights may be retrieved.

The insights may be stored.

In step 250, the insights may be evaluated. For example, embodiments may evaluate the insights with regard to coverage (e.g., the percentage of text data that is categorized into ML discovered topics), labels (e.g., purity, inverse purity, and ARI (Adjusted Rand Index)), and accuracy (e.g., label accuracy, topic accuracy, and topic completeness using, for example, a LLM as a judge. These metrics provide a numeric evaluation value from a range. Accuracy based metrics (e.g., label accuracy, topic accuracy, topic completeness) may use an LLM to evaluate the accuracy of topic assignment to text. Other metrics may use ground truth label information to evaluate the accuracy of the topic to text clusters. For example, given texts that have been assigned to a single topic, the consistency of the ground truth labels assigned to the labels may be evaluated.

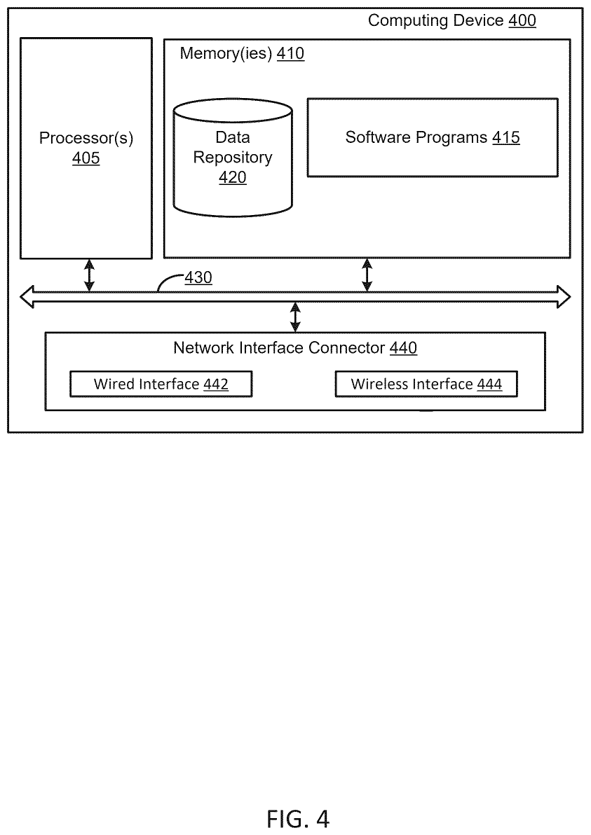

FIG. 4 depicts an exemplary computing system for implementing aspects of the present disclosure. FIG. 4 depicts exemplary computing device 400. Computing device 400 may represent the system components described herein. Computing device 400 may include processor 405 that may be coupled to memory 410. Memory 410 may include volatile memory. Processor 405 may execute computer-executable program code stored in memory 410, such as software programs 415. Software programs 415 may include one or more of the logical steps disclosed herein as a programmatic instruction, which may be executed by processor 405. Memory 410 may also include data repository 420, which may be nonvolatile memory for data persistence. Processor 405 and memory 410 may be coupled by bus 430. Bus 430 may also be coupled to one or more network interface connectors 440, such as wired network interface 442 or wireless network interface 444. Computing device 400 may also have user interface components, such as a screen for displaying graphical user interfaces and receiving input from the user, a mouse, a keyboard and/or other input/output components (not shown).

Although several embodiments have been disclosed, it should be recognized that these embodiments are not exclusive to each other, and features from one embodiment may be used with others.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method, comprising:
receiving, by a computer program, a plurality of text documents;
indexing, by the computer program, the plurality of text documents;
storing, by the computer program, the indexed plurality of text documents in a database;
selecting, by the computer program, a batch of the plurality of text documents from the database;
segmenting, by the computer program, each document in the batch into smaller elements;
clustering, by the computer program, the smaller elements the batch using embeddings for each element;
selecting, by the computer program, elements in each cluster for topic generation;
identifying, by the computer program and using a large language model (LLM), granular topics for each cluster;
organizing, by the computer program, the granular topics into a topic hierarchy;
generating, by the computer program, topic insights on topics from the granular topics; and
evaluating, by the computer program, the topic insights.

2. The method of claim 1, wherein the batch is selected using representative sampling.

3. The method of claim 1, further comprising:
generating, by the computer program and using a large language model, targeted summaries of each text document in the batch.

4. The method of claim 3, further comprising:
preparing, by the computer program, a shorter version of each of the text documents in the batch using data chunking and/or data truncation before generating the targeted summaries.

5. The method of claim 1, wherein the step of organizing the granular topics into a topic hierarchy comprises:
creating, by the computer program and for each cluster, a multi-view embedding vector by concatenating a centroid of the text element embeddings, an embedding of a topic name for the granular topic, and an embedding of a topic description for the granular topic; and
generating, by the computer program and using the LLM, the topic hierarchy based on the multi-view embedding vectors.

6. The method of claim 5, further comprising:
training, by the computer program, a distillation model; and
distilling, by the computer program, labels for the indexed plurality of text documents in the database.

7. The method of claim 6, further comprising:
performing, by the computer program, semantic filtering and semantic deduplication on the labels.

8. The method of claim 7, wherein the semantic filtering comprises key phrase extraction.

9. The method of claim 7, wherein the semantic deduplication comprises encoding and clustering topics.

10. A non-transitory computer readable storage medium, including instructions stored thereon, which when read and executed by one or more computer processors, cause the one or more computer processors to perform steps comprising:
receiving a plurality of text documents;
indexing the plurality of text documents;
storing the indexed plurality of text documents in a database;
selecting a batch of the plurality of text documents from the database;
segmenting each document in the batch into smaller elements;
clustering the smaller elements the batch using embeddings for each element;
selecting elements in each cluster for topic generation;
identifying, using a large language model (LLM), granular topics for each cluster;
organizing the granular topics into a topic hierarchy;
generating topic insights on topics from the granular topics; and
evaluating the topic insights.

11. The non-transitory computer readable storage medium of claim 10, wherein the batch is selected using representative sampling.

12. The non-transitory computer readable storage medium of claim 10, further including instructions stored thereon, which when read and executed by the one or more computer processors, cause the one or more computer processors to perform steps comprising:
generating targeted summaries of each text document in the batch using a large language model.

13. The non-transitory computer readable storage medium of claim 12, further including instructions stored thereon, which when read and executed by the one or more computer processors, cause the one or more computer processors to perform steps comprising:
preparing shorter version of each of the text documents in the batch using data chunking and/or data truncation before generating the targeted summaries.

14. The non-transitory computer readable storage medium of claim 10, wherein the step of organizing the granular topics into a topic hierarchy comprises:
creating, for each cluster, a multi-view embedding vector by concatenating a centroid of the text element embeddings, an embedding of a topic name for the granular topic, and an embedding of a topic description for the granular topic; and
generating, using the LLM, the topic hierarchy based on the multi-view embedding vectors.

15. The non-transitory computer readable storage medium of claim 14, further including instructions stored thereon, which when read and executed by the one or more computer processors, cause the one or more computer processors to perform steps comprising:
training a distillation model; and
distilling labels for the indexed plurality of text documents in the database.

16. The non-transitory computer readable storage medium of claim 15, further including instructions stored thereon, which when read and executed by the one or more computer processors, cause the one or more computer processors to perform steps comprising:
performing semantic filtering and semantic deduplication on the labels.

17. The non-transitory computer readable storage medium of claim 16, wherein the semantic filtering comprises key phrase extraction.

18. The non-transitory computer readable storage medium of claim 16, wherein the semantic deduplication comprises encoding and clustering topics.
